(19) United States
(12) Patent Application Publication
(10) Pub. No.: US 2014/0227397 A1
(43) Pub. Date: Aug. 14, 2014

(54) TEMPERATURE INDICATING PACKAGE AND METHOD OF USING

(71) Applicant: ACH Food Companies, Inc., Cordova, TN (US)

(72) Inventors: Paul Friedman, Germantown, TN (US); Robert Larkin, Johnston, IA (US); Kelsey Kirchhoff, Des Moines, IA (US); Keith Roger Dierberg, Baton Rouge, LA (US)

(73) Assignee: ACH Food Companies, Inc., Cordova, TN (US)

(21) Appl. No.: 14/175,028

(22) Filed: Feb. 7, 2014

Related U.S. Application Data
(60) Provisional application No. 61/762,510, filed on Feb. 8, 2013.

(51) Int. Cl. A23L 1/00; G01K 1/02

(52) U.S. Cl. CPC A23L 1/0008; G01K 1/02
USPC 426/62; 116/216

(57) ABSTRACT

A method for hydrating yeast comprises several steps. A package comprising a thermochromic ink and an indicator is provided. A liquid is provided. The temperature of the liquid is measured by placing the package in contact with the liquid. The liquid is heated or cooled until the thermochromic ink indicates the liquid is within the predetermined temperature range. The liquid and yeast are combined. The package comprises a pouch, a thermochromic ink, and an indicator. The pouch is formed from one or more films sealed together to create an internal space. The thermochromic ink and indicator are arranged relative to each other to indicate when the liquid is within a predetermined temperature range. The thermochromic ink changes color when the liquid is within the predetermined temperature range.

### BACKGROUND

The process for making bread involves the mixing of yeast, sugars, flour, liquids, and salt in proper proportions to form dough. The dough is kneaded and allowed to rise for a period of time. Following the rising period, the dough is then baked and cooled.

Dry yeast is hydrated when it is first added to a liquid such as water or milk. The temperature during this hydration step has an effect on how well the yeast is hydrated. Once the hydrated yeast has been mixed with flour or sugar to form a starter, it begins to grow and ferment while consuming the sugars that are present. This is called proofing. During this time the yeast emits carbon dioxide and other gasses which bubble through the starter. If the temperature of the starter is too low, the yeast will not grow consistently and the dough will not rise properly. If the temperature of the starter is too high, it can kill the yeast which will also cause the dough to not rise properly.

The temperature of the liquids added to the yeast to hydrate it has a great impact on the viability and effectiveness of the yeast.

### BRIEF SUMMARY

A method for hydrating yeast comprises several steps. A package comprising a thermochromic ink and an indicator is provided. A liquid is provided. The temperature of the liquid is measured by placing the package in contact with the liquid. The liquid is heated or cooled until the thermochromic ink indicates the liquid is within the predetermined temperature range. The liquid and yeast are combined.

In some embodiments, the indicator comprises a word, symbol, or color. The liquid is heated or cooled until the thermochromic ink indicates the liquid is within the predetermined temperature range by revealing the indicator, hiding the indicator, or matching the color of the indicator.

A package comprises a pouch, a thermochromic ink, and an indicator. The pouch is formed from one or more films sealed together to create an internal space. The thermochromic ink and indicator are arranged relative to each other to indicate when the liquid is within a predetermined temperature range. The thermochromic ink changes color when the liquid is within the predetermined temperature range.

These and other objects and advantages shall be made apparent from the accompanying drawings and the description thereof.

### BRIEF DESCRIPTION OF THE FIGURES

The accompanying drawings, which are incorporated in and constitute a part of this specification, illustrate embodiments, and together with the general description given above, and the detailed description of the embodiments given below, serve to explain the principles of the present disclosure.

FIG. 1 shows four embodiments of yeast packages with thermochromic ink and indicator in the predetermined temperature range.

FIG. 2 shows four embodiments of the thermochromic ink and indicator at different temperatures.

### DETAILED DESCRIPTION

Yeast may be hydrated with liquid that is at the proper temperature. The liquid is brought to the proper temperature by measuring and adjusting its temperature, guided by the thermochromic ink (21) and the indicator (31) on the yeast package (10). The yeast package (10) comprises a thermochromic ink (21) that indicates when the liquid is within a predetermined temperature range. When the temperature of the liquid is in the predetermined temperature range the yeast and liquid are combined.

A consumer is more likely to adjust the temperature of the liquid used to hydrate the yeast when the yeast package provides a way to measure the temperature. When the liquid used to hydrate the yeast is at the correct temperature the yeast will make better bread. Without a yeast package that comprises a thermochromic ink and indicator, only consumers with thermometers who are fastidious about following directions are likely to measure and adjust the temperature of the liquid so it is at the proper temperature.

The temperature of the liquid is adjusted by heating or cooling the liquid until the thermochromic ink indicates it is within the predetermined temperature range. The terms “adjusted by heating or cooling” also refers to adjusting the temperature of the source of the liquid, such as by adjusting the temperature of the water from a faucet. For example, the thermochromic ink is placed in contact with the stream of water coming from a faucet until it indicates the water is within the predetermined temperature range, the water coming from the faucet is then collected. The collected water is the provided liquid. By adjusting the faucet, the temperature of that water has been adjusted until the thermochromic ink indicates it is within the predetermined temperature range. The temperature of the liquid may be heated or cooled by adding additional hot or cold liquid, by direct heating or cooling, or by substituting new liquid within the predetermined temperature range.

Various liquids may be used to hydrate the yeast. Two common liquids are water and milk. Typically, the liquid will have a high water content.

To proof the yeast requires a sugar source. The sugar source typically contains carbohydrates, but it may contain only simple sugars. In some embodiments the liquid and yeast mixture is mixed with flour, which provides carbohydrates for the yeast to consume. In some embodiments, the yeast and the sugar source are pre-mixed with the yeast in dry form. All that is necessary to start proofing is to add a liquid, which will hydrate the yeast and dissolve some of the sugars.

Proofing the yeast to produce a starter may be done by adding the yeast to a large proportion of liquid, such as about 1 teaspoon (5 mL) of dry yeast, about 1 tablespoon of flour (15 mL), and about 1 cup (235 mL) of liquid. When the yeast is proofed in this way, the flour needed to make the dough is typically added after the yeast has been proofed. However, proofing may be done with considerably less liquid, such as a 1:1 volume of yeast to liquid. When the yeast is proofed in this way, additional liquid and flour is added to make the dough. In some embodiments, hydrating and proofing the yeast is done simultaneously with making the dough. This is done by mixing the yeast, water, and flour in the approximate ratio to create the dough, and not as a separate step. In some embodiments, hydrating the yeast is done simultaneously with proofing the yeast.

The predetermined temperature range for hydrating, proofing, or both, may be below a certain temperature, or within a temperature range. In some embodiments the predetermined temperature range of the liquid is about 80° F. to about 130° F., such as about 80° F. to about 90° F., about 90° F. to about 110° F., about 100° F. to about 120° F., about 100° F. to about 110° F., about 110° F. to about 120° F., about 120° F. to about 130° F., about 90° F. to about 130° F., about 80° F. to about 130° F., about 90° F. to about 120° F., about 80° F. to about 120° F., below about 130° F., below about 132° F., below about 135° F., below about 127° F., or below about 125° F. The predetermined temperature range will depend upon the type of yeast.

The thermochromic ink on a yeast package indicates when it is exposed to liquid within a predetermined temperature range by a change in color. A change in color for the thermochromic ink includes changing from opaque to transparent, transparent to opaque, from one color to another color, or any combination thereof. The thermochromic ink will be at the temperature of the liquid when the package is placed in whole or in part in contact with the liquid. It may take some amount of time for the temperature of the thermochromic ink to match the temperature of the liquid.

When the thermochromic ink is exposed to a liquid that is not within the predetermined temperature range, the thermochromic ink is one color, when the temperature of the liquid is adjusted to be or is already within the predetermined temperature range, the thermochromic ink changes color. That is, the thermochromic ink exhibits one color when the liquid is within the predetermined temperature range and a different color when the liquid is not within the predetermined temperature range.

There are many different mechanisms for how thermochromic inks change color, which are well known in the art. For example, liquid crystals and leuco dyes can be thermochromic inks Different thermochromic inks may change color at different temperatures. In addition, the thermochromic ink may change from one color to a different color, depending on the temperature to which it is exposed. Known inks can be chosen depending on their color and known temperature sensitivity.

The thermochromic ink may be designed so that it exhibits a different color at different temperatures. It may be designed so that it only exhibits a color when it is in a particular temperature range. In some embodiments, the thermochromic ink may change from black to a different color upon being exposed to the predetermined temperature range. In some embodiments, the thermochromic ink may change from substantially transparent to substantially opaque or from substantially opaque to substantially transparent upon being exposed to the predetermined temperature range. In some embodiments, the thermochromic ink is black when it is in the predetermined temperature range. In some embodiments, the thermochromic ink is transparent when it is in the predetermined temperature range. In some embodiments, an indicator comprising text is revealed when the thermochromic ink becomes transparent upon being exposed to the predetermined temperature range. In some embodiments, the color of the indicator matches a color that is revealed when the thermochromic ink becomes transparent. In some embodiments, an indicator, such as a word, is made visible by the changing color of one or more thermochromic inks upon being exposed to the predetermined temperature range. In some embodiments, the thermochromic ink is opaque when in the predetermined temperature range and transparent when above the predetermined temperature range.

In some embodiments, the package (10) has more than one thermochromic ink. In some embodiments, the package (10) will have different indicators to indicate that the temperature is at, below, or above the predetermined temperature range. In some embodiments, the one or more thermochromic inks are spatially arranged to indicate that the temperature is at, below, or above the predetermined temperature range. The location of the thermochromic ink, which has changed color, indicates whether the temperature is at, below, or above the predetermined temperature range. In some embodiments there are second and third thermochromic inks (20, 22).

In some embodiments the thermochromic ink is in the shape of a symbol or text. The thermochromic ink may be shaped so that only the symbol or text changes color with a change in temperature. Alternatively, it may be shaped so that the symbol or text does not change color, but the field around the symbol or text does. The symbol or text may be in a field of thermochromic ink. The symbol or text may be colored to match the color of the thermochromic ink at a particular temperature. When the thermochromic ink is exposed to another temperature, such as the predetermined temperature range, which changes the color of the ink, the symbol or text will no longer match the color of the ink. The contrast will emphasize the symbol or text in a particular temperature range.

In some embodiments, the thermochromic ink covers a symbol, text, or color. When the thermochromic ink is at, below, or above the predetermined temperature range the thermochromic ink is transparent so the symbol, text, or color is visible. Alternatively, when the thermochromic ink is at, below, or above the predetermined temperature range the thermochromic ink is opaque so the symbol, text, or color is not visible.

The indicator is used to indicate that the predetermined temperature range has been reached. The indicator may take different forms, such as a color, text, symbol, or a combination thereof. In some embodiments, the indicator may be a color, where the color of the thermochromic ink matches the color of the indicator when it is within the predetermined temperature range. In some embodiments, the indicator is a color, text, or a symbol that is revealed or emphasized when the thermochromic ink becomes transparent. In some embodiments, the indicator may be hidden at the predetermined temperature range. Alternatively, the thermochromic ink may change color to reveal or emphasize the text of the indicator. In some embodiments, the indicator may be a second or third thermochromic ink. In some embodiments, the thermochromic ink becomes transparent to reveal or emphasize the text or color of the indicator when it is above or below the predetermined temperature range; and the thermochromic ink is opaque when it is in the predetermined temperature range.

For a thermochromic ink, there may be more than one indicator. In some embodiments, the package (10) has a second indicator (30). The second indicator may be used to indicate that the temperature is above or below the predetermined temperature range. The second indicator may take different forms, such as a color, text, symbol, or combination. In some embodiments, the second indicator may be a color, where the color of the thermochromic ink matches the color of the second indicator when it is above or below the predetermined temperature range. In some embodiments, the second indicator is a color, text, or a symbol that is revealed or emphasized when the thermochromic ink becomes transparent. Alternatively, the thermochromic ink may change color to reveal or emphasize the text of the second indicator. For each thermochromic ink, there may be more than one second indicator. In some embodiments, the package (10), has a third indicator (32). The second and third indicators may be used to indicate that the temperature is above or below the predetermined temperature range.

The thermochromic ink and indicator are arranged relative to each other to indicate when the package is within a predetermined temperature range. This allows the user to easily view both the thermochromic ink and the indicator. In some embodiments, the thermochromic ink and indicator may be located on a tear off label or part of the package. This may allow the user to determine if the liquid is within a predetermined temperature range without opening the package or putting the package containing yeast into the liquid.

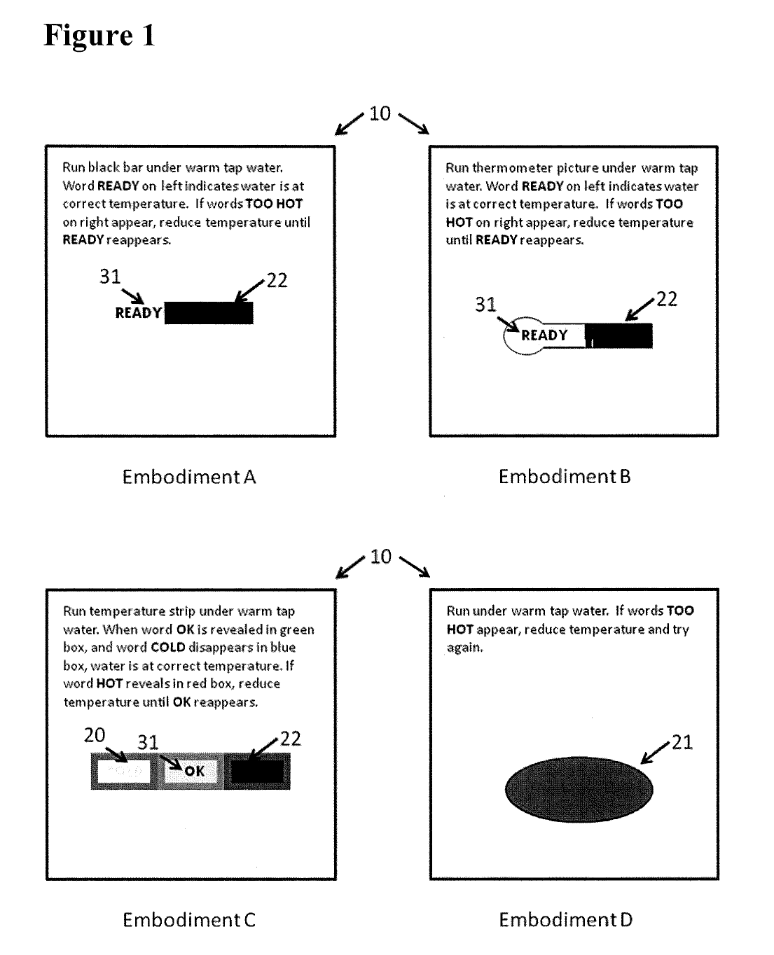

FIG. 1 shows four embodiments of a yeast package in the predetermined temperature range, the package (10) comprises a pouch, a thermochromic ink (which is transparent at the predetermined temperature range), and an indicator (31) which is reveled at the predetermined temperature range. The pouch is formed from one or more films sealed to create an internal space. A second thermochromic ink (22) is opaque at the predetermined temperature range. In embodiment C, at the predetermined temperature range, a third thermochromic ink (20) has faded. In embodiment D, at the predetermined temperature range, the thermochromic ink (21) is opaque and the indicator is hidden.

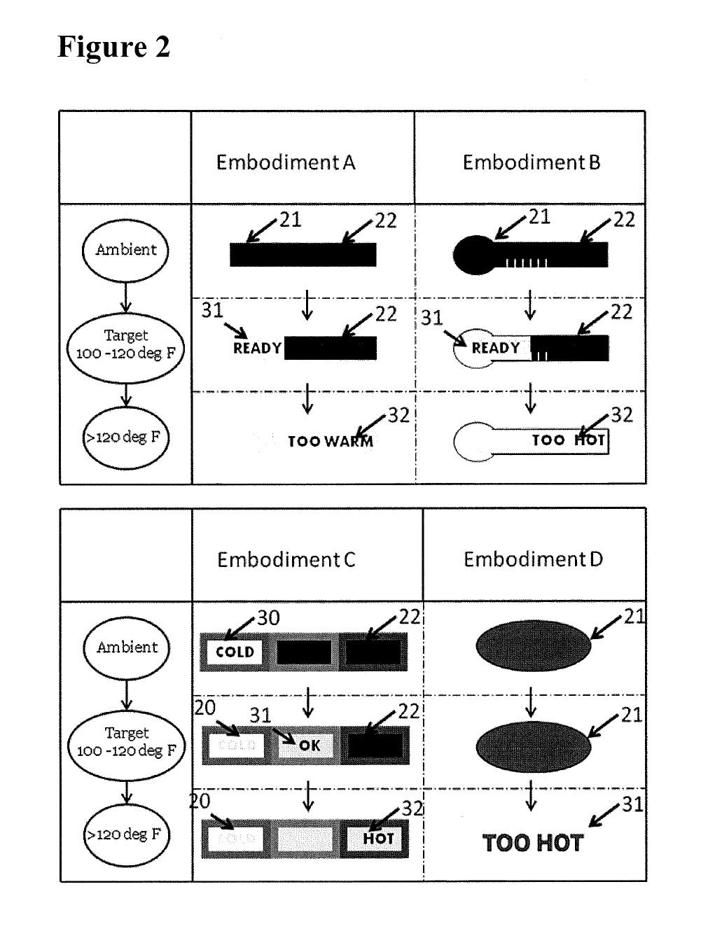

FIG. 2 shows four embodiments of thermochromic inks and indicators, in three different temperature ranges. Embodiments A and B at ambient temperature, which is below the predetermined temperature range, display a thermochromic ink (21) and a second thermochromic ink (22), both of which are opaque. In the predetermined temperature range, the thermochromic ink (21) is transparent, revealing indicator (31); the second thermochromic ink (22) remains opaque. Above the predetermined temperature range, indicator (31), which is also a thermochromic ink, becomes transparent. In addition, the second thermochromic ink (22) becomes transparent, revealing the second indicator (32).

In FIG. 2, Embodiment C at ambient temperature, which is below the predetermined temperature range, displays a thermochromic ink (21) and a second thermochromic ink (22), both of which are opaque. In addition, a third thermochromic ink (30), displays the word “cold” which is a indicator which indicating that the liquid is below the predetermined temperature range. In the predetermined temperature range, the thermochromic ink (21) is transparent, revealing indicator (31), indicating that the liquid is in the predetermined temperature range; the second thermochromic ink (22) remains opaque; and the third thermochromic ink (30) fades. Above the predetermined temperature range, indicator (31), which is also a thermochromic ink, becomes transparent. In addition, the second thermochromic ink (22) becomes transparent, revealing the second indicator (32), indicating that the liquid is above the predetermined temperature range.

In FIG. 2, Embodiment D at ambient temperature and the predetermined temperature range displays a thermochromic ink (21) which is opaque. Above the predetermined temperature range, the thermochromic ink (21) becomes transparent, revealing the indicator (31), indicating that the liquid is above the predetermined temperature range.

In some embodiments the package comprises one or more waterproof films. In some embodiments the one or more films are insulated. An insulated package will protect the yeast from hot or cold liquid during measurement. The package (10) may be placed in contact with the liquid to measure the temperatures. In some embodiments, the package will instruct a consumer to remove the yeast from the package prior to measuring the temperature of the liquid.

In some embodiments the package (10) holds yeast in an internal space. The yeast may be in any form such as dry yeast, liquid yeast, cream yeast, or compressed yeast. Hydrating yeast is more typically done with dry yeast, but it may also be done with any other forms of yeast.

While the present disclosure has illustrated by description several embodiments and while the illustrative embodiments have been described in considerable detail, it is not the intention of the applicant to restrict or in any way to limit the scope of the appended claims to such detail. Additional advantages and modifications may readily appear to those skilled in the art.

What is claimed is:

1. A method for hydrating yeast comprising the steps of:
providing a package of yeast comprising a thermochromic ink and an indicator,
providing a liquid,
adjusting the temperature of the liquid by placing the package in contact with the liquid and heating or cooling the liquid until the thermochromic ink indicates the liquid is within a predetermined temperature range, and
combining the liquid with the yeast.

2. A method for proofing yeast, comprising the steps of claim 1, and further comprising the step of combining the yeast with a source of sugar.

3. The method of claim 1, wherein the color of the thermochromic ink indicates the liquid is within the predetermined temperature range when the color of the thermochromic ink matches the color of the indicator.

4. The method of claim 1, wherein the thermochromic ink indicates the liquid is within the predetermined temperature range when the color of the thermochromic ink becomes transparent and thereby reveals the indicator.

5. The method of claim 1, wherein the thermochromic ink indicates the liquid is within the predetermined temperature range when the color of the thermochromic ink becomes opaque and thereby hides the indicator.

6. The method of claim 1, wherein the indicator comprises text, one or more symbols, or both.

7. The method of claim 1, wherein the predetermined temperature range is about 80° F. to about 130° F.

8. The method of claim 1, wherein the predetermined temperature range is below about 130° F.

9. The method of claim 1, wherein the package comprises more than one thermochromic ink.

10. The method of claim 9, wherein a second thermochromic ink indicates that the liquid is at a temperature above the predetermined temperature range.

11. The method of claim 1, wherein the package comprises a second and a third thermochromic ink, wherein
the second thermochromic ink indicates that the liquid is at a temperature above the predetermined temperature range,
the third thermochromic ink indicates that the liquid is at a temperature below the predetermined temperature range.

12. A package comprising a pouch, a thermochromic ink, and an indicator, wherein
the pouch is formed from one or more films sealed to create an internal space,
the thermochromic ink and indicator are arranged relative to each other to indicate when the package is exposed to a predetermined temperature range, and
wherein the thermochromic ink changes color when the liquid is within the predetermined temperature range.

13. The package of claim 12, wherein the color of the thermochromic ink indicates the liquid is within the predetermined temperature range when the color of the thermochromic ink matches the color of the indicator.

14. The package of claim 12, wherein the thermochromic ink indicates the liquid is within the predetermined temperature range when the color of the thermochromic ink becomes transparent and thereby reveals the indicator.

15. The package of claim 12, wherein the thermochromic ink indicates the liquid is within the predetermined temperature range when the color of the thermochromic ink becomes opaque and thereby hides the indicator.

16. The method of claim 12, wherein the indicator comprises text, one or more symbols, or both.

17. The package of claim 12, wherein the predetermined temperature range is about 80° F. to about 130° F.

18. The package of claim 12, wherein a second thermochromic ink indicates that the thermochromic ink is at a temperature above the predetermined temperature range.

19. The package of claim 12, wherein the package comprises a second and a third thermochromic ink, wherein
the second thermochromic ink indicates that the thermochromic ink is at a temperature above the predetermined temperature range,
the third thermochromic ink indicates that the thermochromic ink is at a temperature below the predetermined temperature range.

20. The package of claim 12, wherein the thermochromic ink is patterned to form a symbol, letter, number, or word.
